(19) United States
(12) Patent Application Publication
(10) Pub. No.: US 2026/0285033 A1
(43) Pub. Date: Sep. 24, 2026

(54) LIQUID DISCHARGE APPARATUS, IMAGE FORMING APPARATUS, LIQUID DISCHARGE HEAD, AND OPERATION METHOD

(71) Applicant: Katsuhiro TOBITA, Ibaraki (JP)

(72) Inventor: Katsuhiro TOBITA, Ibaraki (JP)

(21) Appl. No.: 19/560,178

(22) Filed: Mar. 9, 2026

(30) Foreign Application Priority Data
Mar. 18, 2025 (JP) 2025-043251

(51) Int. Cl. B41J 2/045; B41J 2/14

(52) U.S. Cl. CPC B41J 2/0451; B41J 2/04536; B41J 2/04573; B41J 2/04581; B41J 2/04596; B41J 2/14233

(57) ABSTRACT

A liquid discharge apparatus includes a liquid discharge head and circuitry. The liquid discharge head includes multiple nozzles to discharge a liquid during a printing period; multiple pressure chambers respectively communicating with the multiple nozzles; and a memory that stores a manufacturing history including a discharge history of each of the multiple nozzles at a time of manufacturing the multiple nozzles. The circuitry is configured to measure a residual vibration generated in each of the multiple pressure chambers during a printing period, set a measurement frequency for each of the multiple nozzles based on the manufacturing history stored in the memory and the residual vibration measured, and select a target nozzle, to be measured during the printing period, from the multiple nozzles based on the measurement frequency.

### CROSS-REFERENCE TO RELATED APPLICATIONS

This patent application is based on and claims priority pursuant to 35 U.S.C. § 119(a) to Japanese Patent Application No. 2025-043251, filed on Mar. 18, 2025, in the Japan Patent Office, the entire disclosure of which is hereby incorporated by reference herein.

### BACKGROUND

### Technical Field

The present disclosure relates to a liquid discharge apparatus, an image forming apparatus, a liquid discharge head, and an operation method.

### Related Art

In a liquid discharge apparatus including a liquid discharge head that discharges liquid from a nozzle, a technique of detecting a discharge state for each nozzle by measuring vibration generated for the nozzle is known.

### SUMMARY

The present disclosure described herein provides a liquid discharge apparatus includes a liquid discharge head and circuitry. The liquid discharge head includes multiple nozzles to discharge a liquid during a printing period; multiple pressure chambers respectively communicating with the multiple nozzles; and a memory that stores a manufacturing history including a discharge history of each of the multiple nozzles at a time of manufacturing the multiple nozzles. The circuitry is configured to measure a residual vibration generated in each of the multiple pressure chambers during a printing period, set a measurement frequency for each of the multiple nozzles based on the manufacturing history stored in the memory and the residual vibration measured, and select a target nozzle, to be measured during the printing period, from the multiple nozzles based on the measurement frequency.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic view of an inkjet recording apparatus;

FIG. 2 is a side view of an inkjet recording module in the inkjet recording apparatus;

FIG. 3A is a schematic view illustrating an arrangement example in which an inkjet recording head is arranged in a line head configuration in the inkjet recording apparatus;

FIG. 3B is an enlarged bottom view of an inkjet recording head 15;

FIG. 4 is a perspective view illustrating a configuration of the inkjet recording head forming the inkjet recording module in the inkjet recording apparatus;

FIG. 5 is a functional block diagram illustrating a functional configuration of a set of a drive control board and the inkjet recording head in the inkjet;

FIG. 6 is a circuit diagram of the inkjet recording head and a residual vibration measuring unit of the inkjet recording apparatus;

FIGS. 7A and 7B are schematic views illustrating a mechanism in which residual vibration occurs in an individual pressure chamber of the inkjet recording apparatus FIGS. 8A and 8B are schematic views illustrating a drive waveform and a residual vibration waveform in the inkjet recording apparatus;

FIG. 9 is a diagram illustrating an example in which an amplitude value is detected using the circuit of FIG. 6;

FIG. 10 is a flowchart illustrating processing of calculating and setting a measurement frequency by a residual vibration measuring unit executed in the inkjet recording head of the inkjet recording apparatus;

FIG. 11 is a diagram illustrating a data structure of contents stored in a record unit of the inkjet recording head;

FIG. 12 is a diagram illustrating a data structure of contents stored in a record unit of an inkjet recording head; and

FIG. 13 is a diagram illustrating a data structure of contents stored in a record unit of an inkjet recording head.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

In a case where inspection is performed during continuous printing, an inspection target nozzle is selected and the inspection is performed. In a detection method of a discharge state described above, the number of nozzles that can be inspected in one drive cycle during a high-speed processing operation is limited. Therefore, priority is given to the inspection target nozzles, or the nozzle inspection is performed in a predetermined order or in units of blocks.

For example, a configuration of selecting a nozzle with a small number of times of discharge as the inspection target nozzle based on print data when selecting the inspection target nozzle on which a discharge inspection during printing is performed has been developed. Here, the nozzle with a small number of times of discharge is selected as the inspection target nozzle on the assumption that the nozzle that does not discharge is dried and non-discharge occurs. In contrast, another factor that causes discharge abnormality is a factor when manufacturing. In this technique, since the nozzle with a small number of times of discharge is selected as the inspection target nozzle during printing, it has not been possible to detect at an early stage the discharge abnormality caused by a state when manufacturing, and it has not been sufficient.

In addition, a configuration of controlling whether to supply a high voltage signal to a discharge unit group by switching a switch group according to discharge unit related information read from a memory of a print head has also been developed. However, even with this technique, it has not been possible to detect at an early stage the discharge abnormality caused by the state when manufacturing, and it has not been sufficient.

According to one or multiple embodiments of the present disclosure, it is possible to detect at an early stage the discharge abnormality caused by the state when manufacturing.

Hereinafter, a liquid discharge head, a liquid discharge apparatus including the liquid discharge head, an image forming apparatus including the liquid discharge apparatus, and an operation method using the liquid discharge head according to one or multiple embodiments of the present disclosure will be described in detail with reference to the drawings. However, the liquid discharge head, the liquid discharge apparatus, the image forming apparatus including the liquid discharge apparatus, and the operation method using the liquid discharge head according to the embodiment of the present disclosure are not limited to those described below. In the following description, the same or similar members or functions will be referred to using the same names and reference signs, and detailed description will be omitted as appropriate.

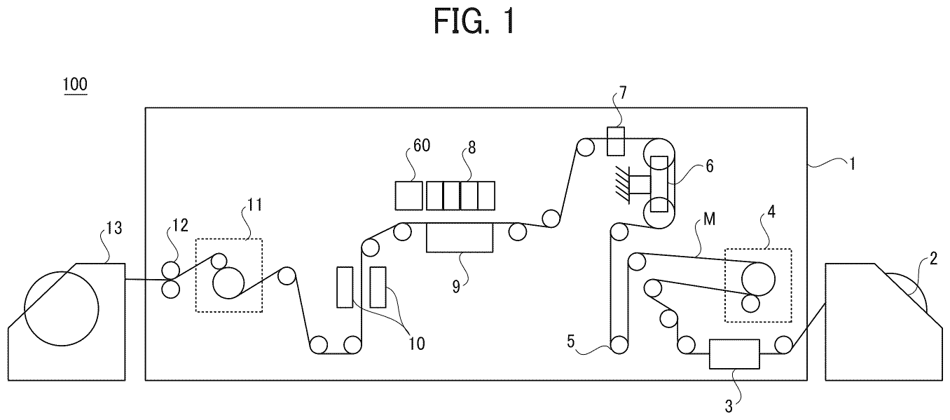

Hereinafter, the image forming apparatus including the liquid discharge apparatus (including the liquid discharge head) according to one or multiple embodiments of the present disclosure will be described with reference to FIGS. 1 to 13. In the embodiment described below, although not particularly limited, an on-demand line scanning type inkjet recording apparatus, and an inkjet recording module and an inkjet recording head thereof will be described as an example of the image forming apparatus, and the liquid discharge apparatus and the liquid discharge head thereof, respectively.

FIG. 1 is a schematic view of an inkjet recording apparatus 100 according to one or multiple embodiments of the present disclosure. The inkjet recording apparatus 100 illustrated in FIG. 1 includes an inkjet recording apparatus main body 1 that records an image on a recording medium M, a recording medium supply unit 2 that supplies the recording medium M, and a recording medium recovery unit 13 that recovers the recording medium M on which the image is recorded.

The inkjet recording apparatus main body 1 includes a regulating guide 3 that performs positioning of the recording medium M in a width direction, an in-feed unit 4 including a driving roller and a driven roller that maintain constant tension of the recording medium M, a dancer roller 5 that moves up and down according to the tension of the recording medium M and outputs a position signal, an edge position control (EPC) 6, a meandering amount detector 7, an inkjet recording module 8, a platen 9 provided facing the inkjet recording module 8, a maintenance/recovery module 60, a drying module 10, an out-feed unit 11 including a driving roller and a driven roller for driving the recording medium M at a set speed, and a puller 12 including a driving roller and a driven roller for ejecting the recording medium M out of the apparatus.

The maintenance/recovery module 60 performs an appropriate maintenance/recovery operation on the inkjet recording module 8 to recover discharging performance of the inkjet recording head. The drying module 10 is a non-contact type or contact type drying device that dries and fixes ink in order to prevent ink printed on the recording medium M from adhering to other portions.

The recording medium M is fed from the recording medium supply unit 2, guided and conveyed by the respective rollers of the in-feed unit 4, the dancer roller 5, the EPC 6, the drying module 10, the out-feed unit 11, and the puller 12, and recovered by the recording medium recovery unit 13. In the described embodiment, the recording medium M is a continuous recording medium, and is also referred to as roll paper, continuous paper, or the like. However, a printing target is not limited to the continuous recording medium M, and may be metal, wood, or ceramics other than a paper sheet and paper of a predetermined size.

The inkjet recording module 8 has a line head configuration of the inkjet recording head in which nozzles that discharge ink for printing are arranged in an entire printing width. Color printing is performed by the line head configuration of each of black (K), cyan (C), magenta (M), and yellow (Y). Nozzle surfaces of the line head configuration are supported on the platen 9 with a predetermined gap therebetween. The inkjet recording module 8 forms a color image on the recording medium M by discharging ink according to a conveyance speed of the recording medium M. The line scanning type enables high-speed image formation.

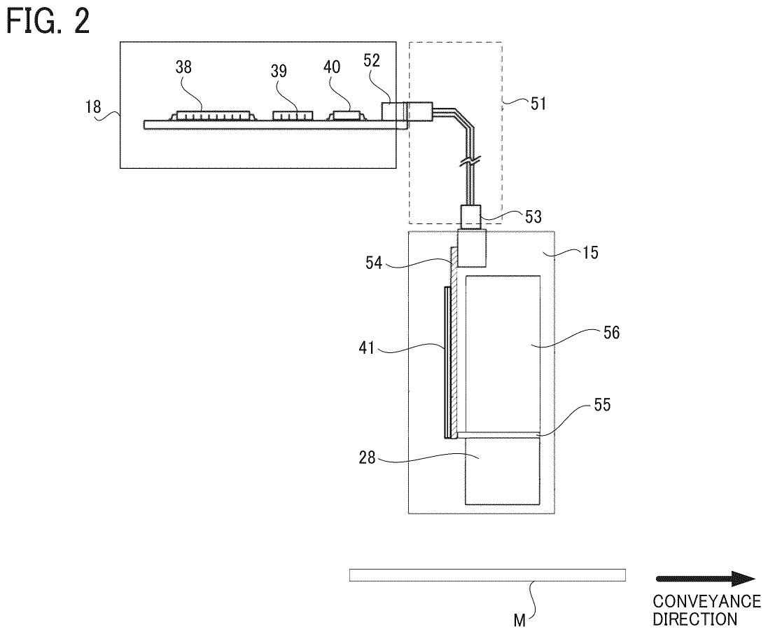

FIG. 2 is a side view of the inkjet recording module 8 in the inkjet recording apparatus 100 according to one or multiple embodiments of the present disclosure. As illustrated in FIG. 2, the inkjet recording module 8 includes a drive control board 18, an inkjet recording head 15, and a cable 51.

The drive control board 18 includes a drive control unit 38, a drive waveform generation unit 39, a storing unit 40, and a connector 52. The drive control board 18 is coupled to, for example, a higher controller such as a control unit of the inkjet recording apparatus main body 1. The inkjet recording head 15 includes a head substrate 54, a residual vibration measuring unit 41, a head drive circuit board 55, an in-head ink tank 56, a rigid plate 28, and a connector 53. The inkjet recording head 15 is coupled to the drive control board 18 via the cable 51.

The cable 51 is attached to the connector 52 on the drive control board 18 side and the connector 53 on the inkjet recording head 15 side. The cable 51 communicates analog signals and digital signals between the drive control board 18 and the head substrate 54 mounted on the inkjet recording head 15.

The line scanning type inkjet recording apparatus 100 has the line head configuration in which multiple inkjet recording heads 15 is arranged in a direction perpendicular to a conveyance direction of the recording medium M (depth direction or front direction of the drawing). However, the present embodiment may be a serial scanning type image forming apparatus, droplet discharge device, or the like that conveys the recording medium M in the conveyance direction while moving one or multiple inkjet recording heads 15 in the direction perpendicular to the conveyance direction of the recording medium M (depth direction or front direction of the drawing) to form an image, and is not limited to the above-described line scanning type inkjet recording apparatus.

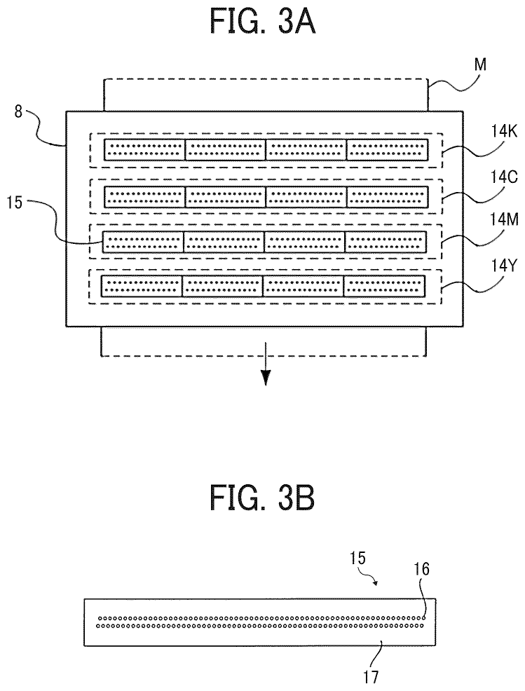

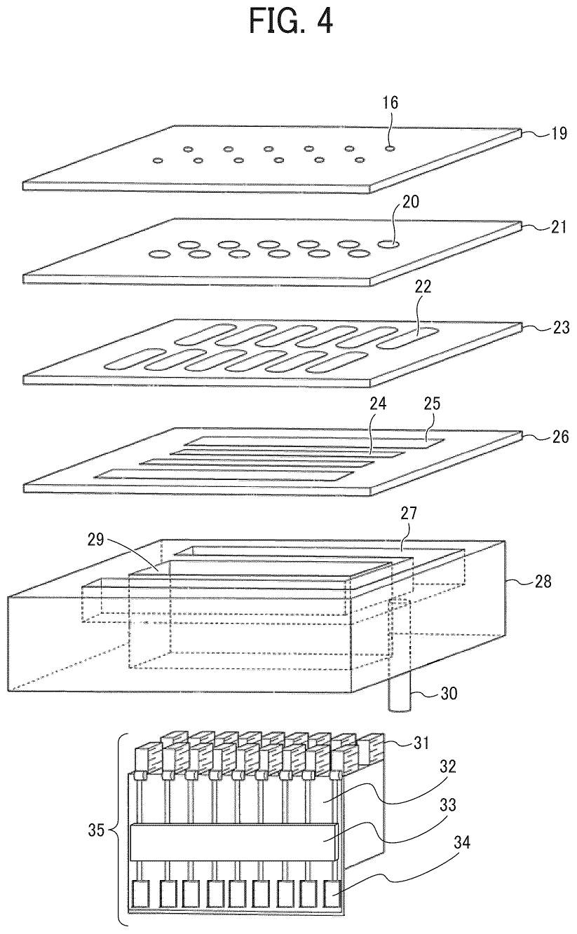

FIG. 3A is a schematic view illustrating an arrangement example in which the inkjet recording heads 15 described above are arranged in the line head configuration. In one or multiple embodiments of the present disclosure, the inkjet recording module 8 includes an assembly of a black head array 14K that discharges black ink droplets, a cyan head array 14C that discharges cyan ink droplets, a magenta head array 14M that discharges magenta ink droplets, and a yellow head array 14Y that discharges yellow ink droplets from an upstream side in the conveyance direction of the recording medium M (arrow direction). The respective head arrays 14K, 14C, 14M, and 14Y are arranged in a direction orthogonal to the conveyance direction of the recording medium M (arrow direction). By arraying the heads in this manner, a wide printing area width can be secured. Types and the number of colors are not limited thereto, and a head array that discharges a treatment liquid such as a pretreatment liquid or a posttreatment liquid may be provided in addition to the head array that discharges the color ink.

FIG. 3B is an enlarged bottom view of a bottom surface of the inkjet recording head 15. Multiple nozzles 16 is arrayed in a staggered manner on a nozzle surface (bottom surface) 17 of the inkjet recording head 15. In the described embodiment, 65 nozzles 16 in each of two lines are arrayed in a staggered manner. By arraying the multiple nozzles 16 in a staggered manner in this manner, it is possible to cope with high resolution.

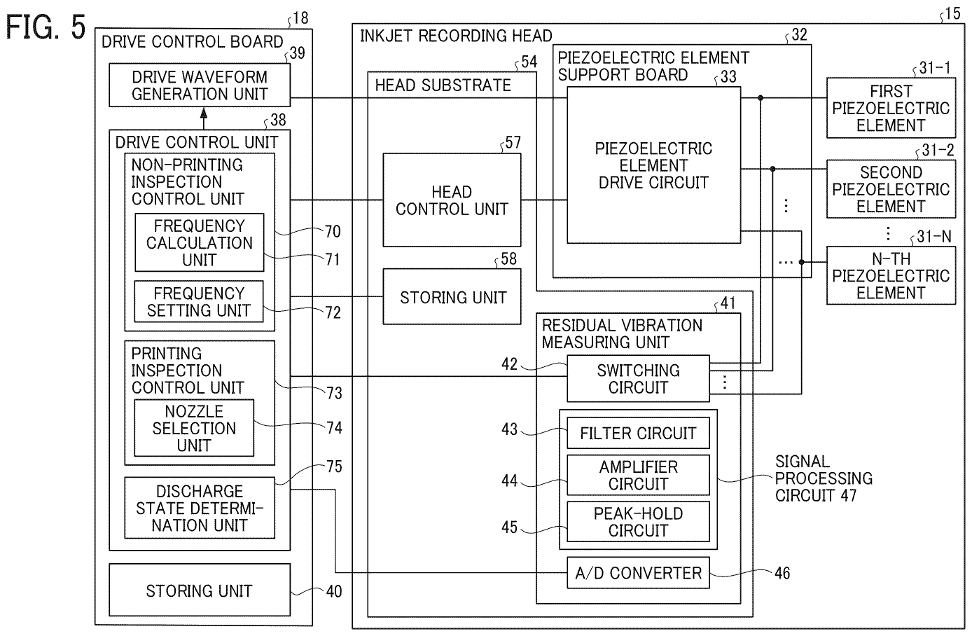

FIG. 4 is a perspective view illustrating a configuration of the inkjet recording head 15. The inkjet recording head 15 includes a nozzle plate 19, a pressure chamber plate 21, a restrictor plate 23, a diaphragm plate 26, a rigid plate 28, and a piezoelectric element group 35. The multiple nozzles 16 is arrayed to be formed in a staggered manner on the nozzle plate 19. On the pressure chamber plate 21, individual pressure chambers (pressure chambers) 20 corresponding to the respective nozzles 16 are formed. The individual pressure chambers 20 each communicate with the nozzle 16 to store ink. In the restrictor plate 23, a restrictor 22 that communicates a common ink channel 27 and the individual pressure chamber 20 to control an ink flow amount to the individual pressure chamber 20 is formed. The diaphragm plate 26 is provided with a diaphragm 24 and a filter 25.

The nozzle plate 19, the pressure chamber plate 21, the restrictor plate 23, and the diaphragm plate 26 are sequentially stacked, positioned, and joined to form a channel plate. Then, the channel plate is joined to the rigid plate 28, and the filter 25 faces an opening of the common ink channel 27. An upper opening end of an ink introduction pipe 30 is coupled to the common ink channel 27 of the rigid plate 28, and a lower opening end of the ink introduction pipe 30 is coupled to an in-head ink tank filled with ink.

A piezoelectric element drive circuit (integrated circuit: IC) 33 is mounted on a piezoelectric element support board 32. Multiple piezoelectric elements 31 corresponding to the respective nozzles 16 is arrayed to form the piezoelectric element group 35. The piezoelectric element group 35 is inserted from an opening 29 provided on the rigid plate 28, and a free end of each piezoelectric element 31 is bonded and fixed to the diaphragm 24, so that the inkjet recording head 15 is formed. In the inkjet recording head 15, the multiple piezoelectric elements 31 is arranged so as to be opposed to the multiple individual pressure chambers 20 to pressurize the multiple individual pressure chambers 20, respectively.

FIG. 4 illustrates the nozzles 16, the individual pressure chambers 20, the restrictors 22, and the like with a reduced number in order to simplify the drawing.

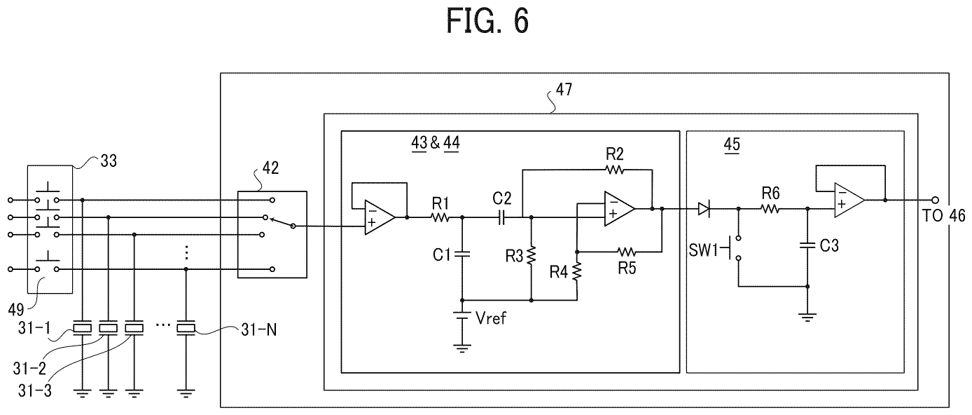

Hereinafter, a functional configuration of the inkjet recording apparatus 100 according to one or multiple embodiments of the present disclosure will be described with reference to FIG. 5. FIG. 5 is a functional block diagram illustrating a functional configuration of a set of the drive control board 18 and the inkjet recording head 15 in the inkjet recording apparatus 100 according to one or multiple embodiments of the present disclosure.

The drive control board 18 illustrated in FIG. 5 includes the drive control unit 38 that generates a timing control signal and drive waveform data based on image data, a drive waveform generation unit 39 that performs digital-to-analog (D/A) conversion on the generated drive waveform data and outputs a drive signal subjected to voltage amplification and current amplification, and the storing unit 40 that stores damping ratio data in advance. The inkjet recording head 15 includes the head substrate 54, the piezoelectric element support board 32, multiple piezoelectric elements 31-1 to 31-N (N=130) provided for multiple nozzles 16-1 to 16-N (N=130 in an example in which 65 nozzles in each of two lines are arrayed in a staggered manner as illustrated in FIG. 3B), and a storing unit 58. The drive waveform generation unit 39 forms a generation unit in the present embodiment that generates a drive waveform for driving the multiple piezoelectric elements 31-1 to 31-N.

The digital signals such as the timing control signal generated by the drive control unit 38 on the drive control board 18 are transmitted to the inkjet recording head 15 by serial communication. The transmitted serial signal is deserialized by the head control unit 57 on the head substrate 54 and input to the piezoelectric element drive circuit 33. The piezoelectric element drive circuit 33 is provided with, for each piezoelectric element, an analog switch that energizes (ON) and shuts off (OFF) in order to select the piezoelectric element 31. The drive waveform generated by the drive waveform generation unit 39 is input to the piezoelectric elements 31-1 to 31-N based on control of energization (ON)/shutoff (OFF) by the analog switch of the piezoelectric element drive circuit 33. The drive control unit 38 transmits a switching signal synchronized with the timing control signal transmitted to the piezoelectric element drive circuit 33 to a switching circuit 42 of the residual vibration measuring unit 41.

A timing at which the residual vibration measuring unit 41 takes in the residual vibration voltage generated in the piezoelectric element 31 after ink discharge is controlled by the switching signal.

The residual vibration measuring unit 41 is provided in common for the multiple nozzles 16-1 to 16-N and the multiple piezoelectric elements 31-1 to 31-N. The residual vibration measuring unit 41 drives the piezoelectric element 31 of the nozzle 16 selected out of the multiple nozzles 16-1 to 16-N, and then measures the residual vibration generated in the corresponding pressure chamber 20 by the piezoelectric element 31.

More specifically, the residual vibration measuring unit 41 includes the switching circuit 42, a filter circuit 43, an amplifier circuit 44, a peak-hold circuit 45, and an analog-to-digital (A/D) converter 46. A circuit including the filter circuit 43, the amplifier circuit 44, and the peak-hold circuit 45 is referred to as a waveform processing circuit 47.

An amplitude value held by the peak-hold circuit 45 is converted into a digital value by the A/D converter 46 and then fed back to the drive control unit 38. The drive control unit 38 calculates a damping ratio based on the fed back amplitude value, and compares the damping ratio with damping ratio data stored in advance in the storing unit 40 to determine a discharge state of each nozzle 16. Thus, the nozzle 16 is inspected. In the described embodiment, it is described that the head control unit 57 having a function of calculating the damping ratio is included in the inkjet recording head 15, but there is no limitation. In another embodiment, the function for calculating the damping ratio may be mounted on the drive control board 18 side. Some or all of the functions mounted on the residual vibration measuring unit 41 may be mounted on the drive control board 18 side.

In FIG. 5, a configuration of detecting the residual vibration voltages of the multiple piezoelectric elements 31-1 to 31-N while sequentially switching using a set of the switching circuit 42, the waveform processing circuit 47, and the A/D converter 46 will be described. However, it is not limited to the embodiment illustrated in FIG. 5, and in another embodiment, a configuration of dividing all the piezoelectric elements into multiple groups, and sequentially switching in each group while providing the switching circuit 42, the waveform processing circuit 47, and the A/D converter 46 for each group may be adopted. In this manner, the number of nozzles the states of which can be simultaneously determined increases, and the number of circuits decreases.

The storing unit 40 is a nonvolatile memory or the like mounted in the drive control board 18. The storing unit 58 is a nonvolatile memory (rewritable recording medium) or the like mounted in the inkjet recording head 15.

In a case of measuring the residual vibration of the individual pressure chamber 20 to determine the discharge state for each nozzle after deforming the piezoelectric element 31 described above, since a damped waveform including multiple amplitudes is used to be described later, a time longer than one drive pulse is involved, and the number of nozzles that can be inspected in one drive cycle during printing is limited. Therefore, in a case where the inspection is performed during printing, the inspection target nozzle is selected and the inspection is performed.

As a method of selecting the inspection target nozzle during printing, a technique of selecting the nozzle with a small number of times of discharge as the inspection target nozzle based on the print data is known. This is on the assumption that the nozzle is dried by not discharging and non-discharge occurs. In contrast, in a case of inkjet of conveying a medium at a high speed, discharge is performed with a discharge waveform having a large amplitude immediately before starting printing or between pages during printing and thickened ink in the pressure chamber 20 can be ejected, so that drying of the nozzle 16 is suppressed even if there is a non-printing nozzle in the page. In the inkjet recording head 15 having an ink circulation function, drying of the non-printing nozzle is prevented by circulating ink in the vicinity of the individual liquid chamber. From this background, a need to make the nozzle with a small number of times of discharge the inspection target nozzle is small. Rather, there are other factors that cause discharge abnormality such as deterioration in nozzle, joint, and the like. As described above, since the inkjet recording head 15 is manufactured by stacking and pressing multiple plates with an adhesive, peeling of the joint may occur due to factors such as application of the adhesive and variation in pressure contact force, and therefore early detection of a discharge abnormality caused by the manufacturing state is desirable.

Hereinafter, with further reference to FIG. 5, the inspection of the inkjet recording head 15 that can detect at an early stage the discharge abnormality caused by the state when manufacturing will be described more specifically.

FIG. 5 illustrates a detailed configuration of the drive control unit 38. Hereinafter, processing of inspecting the discharge state of the nozzle in the inkjet recording apparatus 100 according to one or multiple embodiments of the present disclosure will be described more specifically with reference to FIG. 5.

In the described embodiment, the storing unit 58 in the inkjet recording head 15 stores a manufacturing history (a non-discharge history) for the multiple nozzles 16-1 to 16-N acquired by various inspections when manufacturing the inkjet recording head 15. Examples of the manufacturing history include information regarding a nozzle in which non-discharge occurs at an image printing step but recovered by recovery processing (conforming to a predetermined standard by the recovery processing) in the inspection when manufacturing, information regarding a nozzle in which some inspection results do not reach a predetermined value on an image but having a significant difference from other nozzles (regarding the inspection result, there is a significant difference from other nozzles in a range conforming to a predetermined standard), and information regarding a nozzle in which a discharge speed falls within a standard value but having a significant decreasing trend in a part of the nozzle line (the discharge speed has a significant decreasing trend in a range of conforming to a predetermined standard). The storing unit 58 forms a first storing unit (a first memory) that stores the manufacturing history in the present embodiment.

More specifically, the drive control unit 38 illustrated in FIG. 5 includes a non-printing inspection control unit 70, a printing inspection control unit 73, and a discharge state determination unit 75.

The discharge state determination unit 75 calculates a damping ratio when measuring based on the amplitude value (output of the residual vibration measuring unit 41) fed back from the inkjet recording head 15, and compares the damping ratio with damping ratio data stored in advance in the storing unit 40, thereby determining the discharge state of the droplet of each of the multiple nozzles 16. The discharge state determination unit 75 forms a determination unit in the present embodiment.

Here, examples of the discharge state to be determined include a “normal discharge state” and an “abnormal discharge state”. In the present disclosure, the “normal discharge state” means a state in which the ink droplet is normally discharged from the nozzle. The “abnormal discharge state” means a state in which the ink droplet is not discharged from the nozzle (non-discharge), a state in which an appropriate amount of ink droplet is not discharged from the nozzle, a state in which the ink droplet does not land at an appropriate position, and the like. It is possible to determine the “abnormal discharge state” in further detailed sections.

Hereinafter, the abnormal discharge state of the nozzle will be described. During printing, since the ink in the pressure chamber 20 is in contact with outside air via the opening of the nozzle 16, a solvent evaporates and viscosity increases due to an influence of a change in ambient temperature and humidity, heat generation by continuous driving, and the like. There may be defects such as mixture of bubbles into the pressure chamber 20, adhesion of paper dust to the nozzle surface, and generation of a liquid pool near the nozzle. As a result, there is a disadvantage that the discharge speed of the ink fluctuates for each nozzle, and an abnormal image such as density unevenness, streaks, or color change is caused. Moreover, as thickening of the ink progresses, thickened ink is clogged in the nozzle (discharge failure), and dot missing (pixel missing) occurs in an image forming area. Peeling of the joint occurs due to factors such as application of the adhesive used for manufacturing the inkjet recording head 15 and variation in pressure contact force, and as a result, abnormalities such as color change, discharge failure, and dot missing as described above may occur.

In the described embodiment, it is described on the assumption that the nozzle in the abnormal discharge state is simply recorded as a history. However, regarding a determination result, it is possible to instruct the higher controller to perform an appropriate maintenance/recovery operation (for example, suction operation, wiping operation, flushing operation, and the like) on the inkjet recording module 8 by using the maintenance/recovery module 60 in a case where a certain number or more of the nozzles are put into the abnormal discharge state.

During a non-printing period, the non-printing inspection control unit 70 causes the residual vibration measuring unit 41 to sequentially measure the residual vibrations for all of the multiple nozzles 16-1 to 16-N, determines the discharge state of the nozzle by the discharge state determination unit 75, and stores a determination history of the discharge state of the nozzle in the storing unit 58.

Here, the non-printing period is, for example, a period other than a period in which a printing operation (processing operation) is performed, such as a preparation stage after power-on of the inkjet recording apparatus 100, when performing maintenance, or before a print job is started. The storing unit 58 forms a second storing unit (a second memory) in the present embodiment.

The non-printing inspection control unit 70 according to the described embodiment further includes a frequency calculation unit 71 and a frequency setting unit 72.

The frequency calculation unit 71 reads at least the manufacturing history stored in the storing unit 58, and sets multiple measurement frequencies (inspection frequencies) of measurement performed during the printing period for the multiple nozzles 16 based on the manufacturing history. Here, setting the multiple measurement frequencies means setting different frequencies for the multiple nozzles 16, such as setting a relatively high frequency for at least a part of the multiple nozzles 16 as compared with another part or a remaining part of the multiple nozzles 16. In a specific embodiment, the measurement frequency is set for each nozzle 16.

In a preferred embodiment, the frequency calculation unit 71 reads the determination history of the non-printing period performed in advance in addition to the manufacturing history stored in the storing unit 58, and calculates the multiple measurement frequencies of the measurement performed during the printing period based on the manufacturing history and the determination history of the non-printing period. The frequency setting unit 72 stores the measurement frequency for each nozzle calculated by the frequency calculation unit 71 in the storing unit 58. The storing unit 58 forms a setting storing unit in the present embodiment.

More specifically, the frequency calculation unit 71 compares a value indicating normality or abnormality of the inspection result of the manufacturing history with a value indicating normality or abnormality of the determination history of all nozzles during the non-printing period, and calculates the measurement frequency by a predetermined calculation formula. The frequency calculation unit 71 preferably calculates the multiple measurement frequencies for the multiple nozzles 16 so that the measurement frequency of the nozzle that indicates abnormality in the manufacturing history and indicates abnormality in the determination history during the printing period becomes relatively higher than that of other nozzles, and the frequency setting unit 72 sets the calculated measurement frequencies.

In this manner, the frequency of detecting the residual vibration during the printing period is increased for the nozzle (e.g., an abnormal nozzle) having an abnormality history in both the manufacturing history and the determination history during the non-printing period. Accordingly, it is possible to set the measurement frequency of the nozzle having abnormality in both the manufacturing history and the determination history of all nozzles to be high.

In the described embodiment, it is described that the measurement frequency of the measurement performed during the printing period is calculated and set after the inspection for all the nozzles performed during the non-printing period by the non-printing inspection control unit 70. However, the calculation and setting of the measurement frequency of the measurement performed during the printing period are not limited to those in the above-described embodiment. In another embodiment, they may be performed at a timing different from that of the inspection for all the nozzles performed during the non-printing period by the non-printing inspection control unit 70. That is, the frequency calculation unit 71 and the frequency setting unit 72 may be implemented as configurations independent of the non-printing inspection control unit 70.

During the printing period, the printing inspection control unit 73 executes the nozzle inspection using the residual vibration measuring unit 41 and the discharge state determination unit 75 for the nozzle 16 selected from the multiple nozzles 16-1 to 16-N based on the measurement frequency set by the frequency setting unit 72. The printing inspection control unit 73 then stores the determination result of the determined discharge state in the storing unit 58 as the determination history. The inspection during the printing period can be performed at a time point corresponding to a non-printing area, such as a period between pages (break timing).

The printing inspection control unit 73 includes a nozzle selection unit 74. The nozzle selection unit 74 selects the nozzle 16 to be inspected from the multiple nozzles 16-1 to 16-N and the corresponding piezoelectric element 31. Thus, the drive waveform for detecting the residual vibration is output from the drive waveform generation unit 39 to the inkjet recording head 15 at the timing between pages, and the discharge state of the nozzle can be detected by the residual vibration measuring unit 41. The nozzle selection unit 74 forms a selection unit in the present embodiment.

In a case where the nozzles are selected and inspected in order from a nozzle number 1 to a nozzle number N, the inspection of a nozzle group in which the measurement frequency is increased can be performed for each predetermined number of nozzles. For example, the nozzle group in which the measurement frequency equal to or higher than a predetermined threshold is set is set as a high-frequency inspection target nozzle, and the other nozzles are set as normal nozzles. For example, in a case where there are a total of 1,000 nozzles, when the inspection of the high-frequency inspection target nozzle group is performed every 300 nozzles, the measurement frequency is about three times. That is, after first inspection of the high-frequency inspection target nozzle group is sequentially performed, the inspection as for the normal nozzle group in a range from the nozzle number 1 to a nozzle number 300 is sequentially performed. Subsequently, after second inspection of the high-frequency inspection target nozzle group is performed, the inspection as for the normal nozzle group in a range from a nozzle number 301 to a nozzle number 600 is sequentially performed. Then, the inspection is performed in such a manner that after third inspection of the high-frequency inspection target nozzle group is performed, the inspection as for the normal nozzle group in a range from a nozzle number 601 to a nozzle number 900 is sequentially performed.

Alternatively, the inspection of the high-frequency inspection target nozzle group may be performed for each predetermined number of pages. That is, the measurement frequency can be increased by additionally inserting the inspection of the high-frequency inspection target nozzle group for each predetermined number of pages while performing the inspection of the nozzle at the timing between the pages in the normal order. The calculation of the measurement frequency will be described later in detail.

In the embodiment described above, it has been described to inspect while dividing into two groups of the high-frequency inspection target nozzle group and the other normal nozzle group. However, in another embodiment, in addition to dividing into two as described above, it is possible to perform the inspection while dividing into three or more nozzles such as the high-frequency inspection target nozzle, an intermediate-frequency (between high-frequency and normal frequency) inspection target nozzle, and the normal nozzle.

In the described embodiment, it has been described that the inspection during the printing period is performed at the time point corresponding to the non-printing area such as the period between pages (break timing). However, the embodiment is not limited thereto. For example, as for a nozzle that performs a normal printing operation with a drive waveform for normal printing instead of the drive waveform for detecting the residual vibration, it is possible to inspect the discharge state by detecting the residual vibration after driving by a normal drive signal for the printing operation. In this case also, it is sufficient that the inspection target nozzle 16 is selected based on the set measurement frequency.

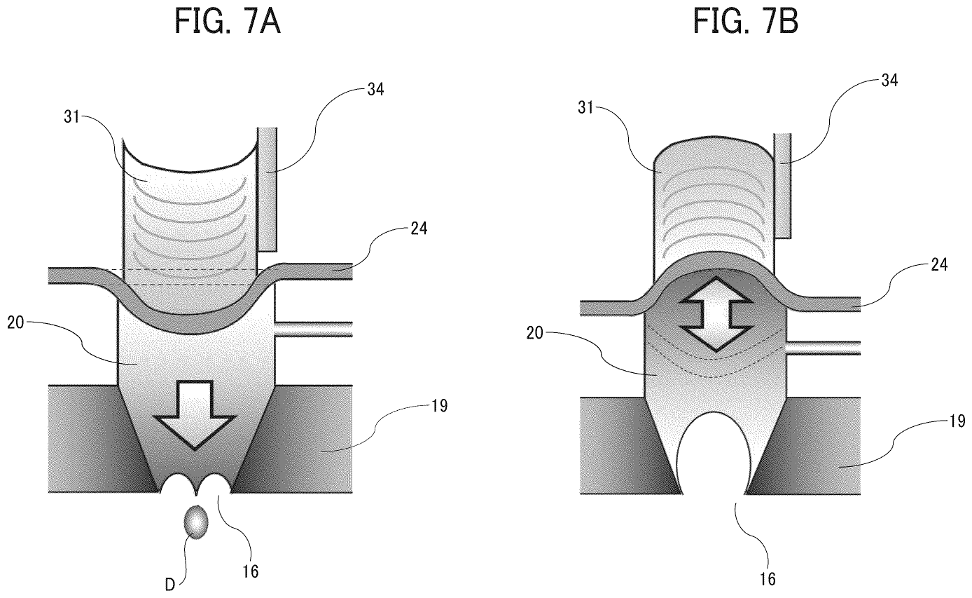

FIG. 6 is a circuit diagram of the inkjet recording head 15 and the residual vibration measuring unit 41 according to one or multiple embodiments of the present disclosure. By controlling a timing to energize (ON)/shut off (OFF) the switch 49 of the piezoelectric element drive circuit 33, any pulse waveform of the drive waveform is applied to each piezoelectric element 31, and various ink droplet types (for example, “large”, “medium”, “small”, and the like) are discharged from the nozzle 16. After the ink discharge, the switching circuit 42 is switched to the selected piezoelectric element 31 at a timing when the switch 49 of the piezoelectric element drive circuit 33 is shut off (OFF), and the selected piezoelectric element 31 is coupled to the waveform processing circuit 47, so that the amplitude value of the residual vibration waveform generated in the selected piezoelectric element 31 is detected.

In the waveform processing circuit 47, an influence of a detection circuit on the residual vibration waveform is suppressed by receiving a minute residual vibration waveform by a high-impedance buffer. The filter circuit 43 and the amplifier circuit 44 are formed of a band-pass filter amplification type generally referred to as a Sallen-Key type. A characteristic of the filter circuit 43 has a certain pass bandwidth with a meniscus natural vibration frequency determined by a characteristic of the inkjet recording head 15 as a center frequency. For example, by setting a bandwidth of −3 dB from both ends of the pass bandwidth to about three times the pass bandwidth, variation in the natural vibration frequency caused by manufacturing variation of the inkjet recording head 15 can be absorbed, and high-frequency and low-frequency noises can be efficiently removed. An amplification factor of the amplifier circuit 44 is set to amplify the waveform within an inputtable range of the A/D converter. A resistor R6 and a capacitor C3 of the peak-hold circuit are determined such that a discharge time is ½ or less of the residual vibration cycle.

The peak-hold circuit 45 is reset, for example, at a timing at which rising of a damped vibration waveform crosses a reference voltage Vref, and the drive control unit 38 inputs a reset signal to a switch SW1.

Alternatively, the timing of crossing can be detected by a comparison circuit, and the reset signal can be input to the switch SW1 by the drive control unit 38. Note that, the timing is not particularly limited as long as this is the reset timing at which the amplitude value of the damped vibration waveform can be detected. The configuration of the peak-hold circuit is not limited to that of FIG. 6 described above, and may be any circuit configuration having a peak-hold function.

The filter circuit 43 and the amplifier circuit 44 are not limited to the Sallen-Key type as long as they have a configuration of a filter having a high-pass characteristic and a low-pass characteristic and a non-inverting amplifier or an inverting amplifier. Furthermore, resistors R1 to R6 and capacitors C1 to C3 may be configured to be variably controlled by the drive control unit 38 according to a difference in natural vibration frequency caused by the characteristic of the inkjet recording head 15.

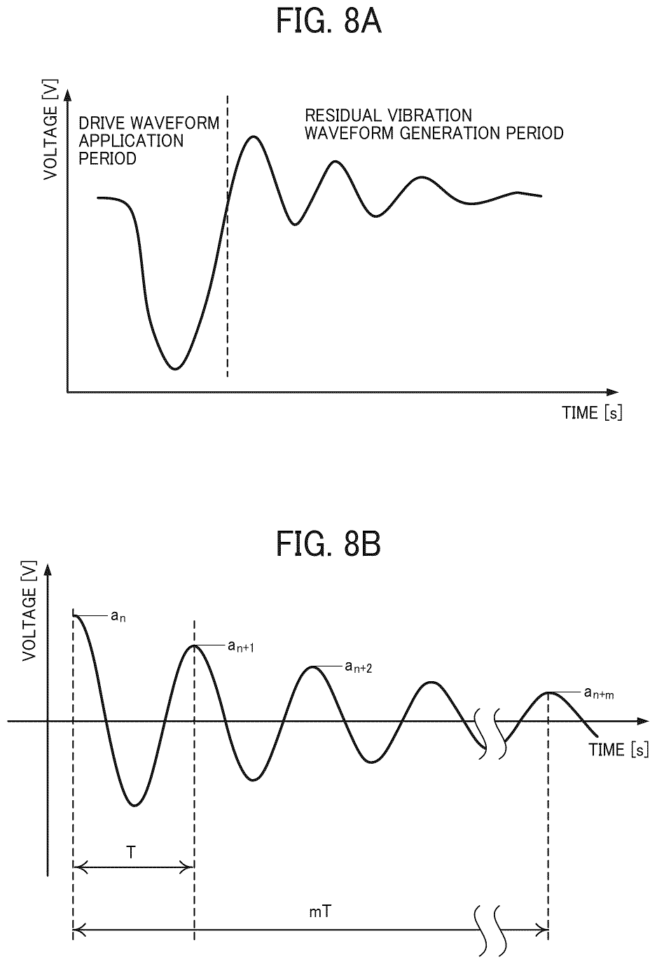

Hereinafter, processing of detecting the residual vibration of each nozzle 16 will be described more specifically with reference to FIGS. 7A and 7B to FIG. 9. FIGS. 7A and 7B are schematic views illustrating a mechanism in which the residual vibration occurs in the individual pressure chamber 20.

FIG. 7A illustrates a pressure change occurring in the individual pressure chamber 20 at the time of ink discharge. FIG. 7B illustrates a pressure change occurring in the individual pressure chamber 20 after ink discharge. At the time of ink discharge, the switch 49 of the piezoelectric element drive circuit 33 is energized (ON)/shut off (OFF) according to the image data transmitted from the drive control board 18, and the drive waveform is applied to an electrode pad 34. An expansion/compression force of the piezoelectric element 31 based on the drive waveform changes the pressure in the individual pressure chamber 20 via the diaphragm 24, thereby generating a pressure in a direction of the nozzle 16 and discharging the ink droplet D as illustrated in FIG. 7A. After the ink discharge, as illustrated in FIG. 7B, a residual pressure wave generated in the individual pressure chamber 20 after the ink droplet D is discharged propagates to the piezoelectric element 31 via the diaphragm 24. As a result, the residual vibration voltage is induced in the electrode pad 34. By detecting a change in induced residual vibration voltage, it is possible to grasp the discharge state of the ink droplet D for each nozzle and abnormality of a component that allows the above-described ink droplet D to be discharged.

FIG. 8A is a schematic view illustrating the drive waveform and the residual vibration waveform. A drive waveform application period illustrated in FIG. 8A corresponds to the operation of FIG. 7A. By expanding the piezoelectric element 31 by a rising operation after compressing the same by a falling operation of the drive waveform, the ink droplet D is discharged. After the drive waveform is applied (that is, after the ink is discharged), the residual vibration is generated as illustrated in FIG. 8A. A residual vibration waveform generation period in FIG. 8A corresponds to the operation of FIG. 7B. The residual pressure wave propagates to the piezoelectric element 31 via the diaphragm 24, so that the damped vibration waveform as illustrated in FIG. 8A is obtained.

In the description with reference to FIGS. 7A and 7B and FIGS. 8A and 8B, the residual vibration voltage when the drive waveform is applied and the ink droplet D is discharged has been described. However, the residual vibration is generated also in a case where a fine drive waveform smaller than a normal drive waveform for discharging the ink droplet D is applied and a surface (meniscus) of the ink is vibrated to such an extent that the ink is not discharged. The waveform (inspection waveform) that generates the residual vibration may be the fine drive waveform in consideration of a running cost, or may be a droplet discharging drive waveform for reliably discharging the ink.

Hereinafter, with reference to FIG. 8B, a process of calculating the damping ratio focusing on the damping ratio of the damped vibration when grasping the nozzle state from the residual vibration waveform will be described below. The residual vibration waveform is the damped vibration as illustrated in FIGS. 8A and 8B. A theoretical formula of the damped vibration is given by the following formula (1).

$$\begin{matrix}[ Math . 1 ] & \\ x = {e}^{- ζ {ω}_{0} t} ( {x}_{0} cos {ω}_{d} t + \frac{ζ {ω}_{0} {x}_{0} + {v}_{0}}{{ω}_{d}} sin {ω}_{d} t ) & ( 1 )\end{matrix}$$

In formula (1) described above, x represents a damped vibration displacement with respect to time, x₀ represents an initial displacement, (represents a damping ratio, ω₀ represents a natural vibration frequency, ω_{d} represents a natural vibration frequency of a damping system, v₀ represents an initial speed, and t represents time. The natural vibration frequency ω_{d} of the damping system is expressed by the following formula (2).

$$\begin{matrix}[ Math . 2 ] & \\ {ω}_{d} = \sqrt{1 - {ζ}^{2}} {ω}_{0} & ( 2 )\end{matrix}$$

As a parameter necessary for calculating the damping ratio ζ, there is a logarithmic damping factor δ. The logarithmic damping factor δ is expressed by the following formula (3).

$$\begin{matrix}[ Math . 3 ] & \\ δ = \frac{1}{m} ln \frac{{a}_{n}}{{a}_{n + m}} & ( 3 )\end{matrix}$$

In FIG. 8B, aₙ in formula (3) described above represents an n-th amplitude value, and aₙ₊ₘ represents an (n+m)-th amplitude value. In the drawing, T represents one cycle, and the logarithmic damping factor δ represents a value obtained by making a ratio of an amplitude change logarithmic and dividing the same by m, thereby averaging the same per one cycle. Note that n and m described above are natural numbers. Therefore, the damping ratio ζ can be expressed by the following formula (4) using the logarithmic damping factor δ.

$$\begin{matrix}[ Math . 4 ] & \\ ζ = \frac{δ}{2 π} & ( 4 )\end{matrix}$$

The damping ratio ζ has information obtained by averaging the damping factors of amplitude values for multiple cycles per one cycle. Therefore, in order to calculate the damping ratio ζ of the damped vibration from formulae (1) to (4) described above, it is sufficient to obtain the logarithmic damping factor δ. In order to obtain the logarithmic damping factor δ, it is sufficient to identify the amplitude values of the residual vibration waveforms at least at two points. The amplitude value may be either a maximum value or a minimum value.

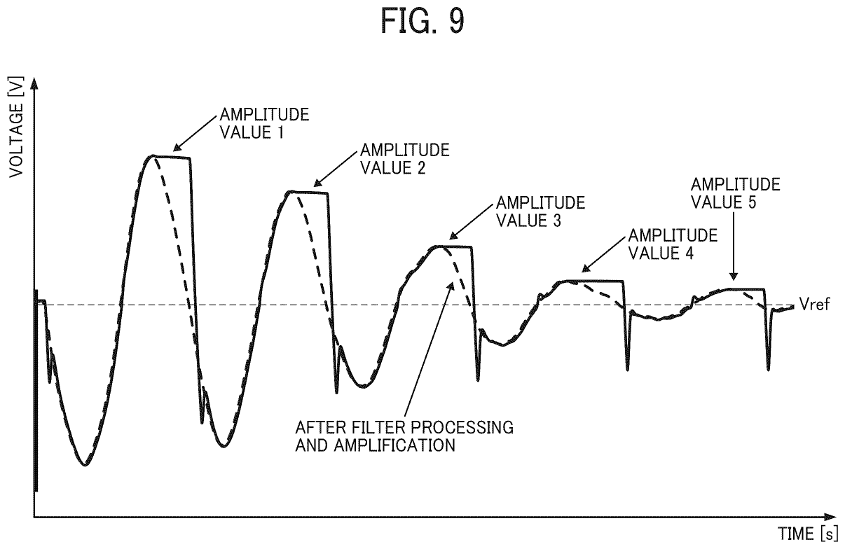

FIG. 9 is a diagram illustrating an example in which the amplitude value is detected using the circuit of FIG. 6 according to the embodiment of the present disclosure. In FIG. 9, a dotted waveform is a waveform after being subjected to filter processing and amplified using the circuit of FIG. 6. In FIG. 9, a solid waveform is a waveform fixed at a peak value of the amplitude value. In FIG. 9, the amplitude value is fixed at five peak values, and an amplitude value of a first half wave is referred to as “amplitude value 1”, an amplitude value of a second half wave is referred to as “amplitude value 2”, an amplitude value of a third half wave is referred to as “amplitude value 3”, an amplitude value of a fourth half wave is referred to as “amplitude value 4”, and an amplitude value of a fifth half wave is referred to as “amplitude value 5”, respectively. A steep waveform found below the reference voltage Vref is an undershoot due to instantaneous discharge of the capacitor C3 of the peak-hold circuit 45 in FIG. 6.

The damping ratio ζ can be calculated by selecting at least two amplitude values out of “amplitude value 1” to “amplitude value 5” by the drive control unit 38 and using formulae (3) and (4) described above. FIG. 9 illustrates a waveform in a case where the amplitude value 1 to the amplitude value 5 on an upper side of vertical amplitude are detected, and it is possible to calculate the damping ratio ζ obtained by averaging the four cycles. However, there is no limitation, and it is possible to detect the amplitude values only on a lower side of the vertical amplitude to calculate the damping ratio ζ. In a case where the upper amplitude values on the upper side of the vertical amplitude are used when calculating the damping ratio (, the amplifier circuit may be applied to the waveform processing circuit 47. In contrast, in a case where the lower amplitude values on the lower side of the vertical amplitude are used when calculating the damping ratio ζ an inverting amplifier circuit may be applied to the waveform processing circuit 47.

The drive control unit 38 can improve calculation accuracy of the damping ratio ζ by appropriately selecting the amplitude value. For example, the drive control unit 38 may select the amplitude value to be used for calculation out of the amplitude value 2, the amplitude value 3, the amplitude value 4, and the amplitude value 5 except for the first amplitude value 1, and thus, it is possible to make the switching circuit 42 less susceptible to the influence of variation. Alternatively, for example, the drive control unit 38 may select the amplitude value to be used for calculation out of the amplitude value 1, the amplitude value 2, the amplitude value 3, and the amplitude value 4 except for the amplitude value 5, and thus, it is possible to make a detection error small. Alternatively, the drive control unit 38 may select the amplitude value to be used for calculation from the amplitude value 2, the amplitude value 3, and the amplitude value 4 except for both the amplitude value 1 and amplitude value 5. Furthermore, the damping ratio ζ may be calculated by averaging cycles excluding half waves having large disturbance influence and noise.

The above-described operation is a residual vibration detection technique using the piezoelectric element 31.

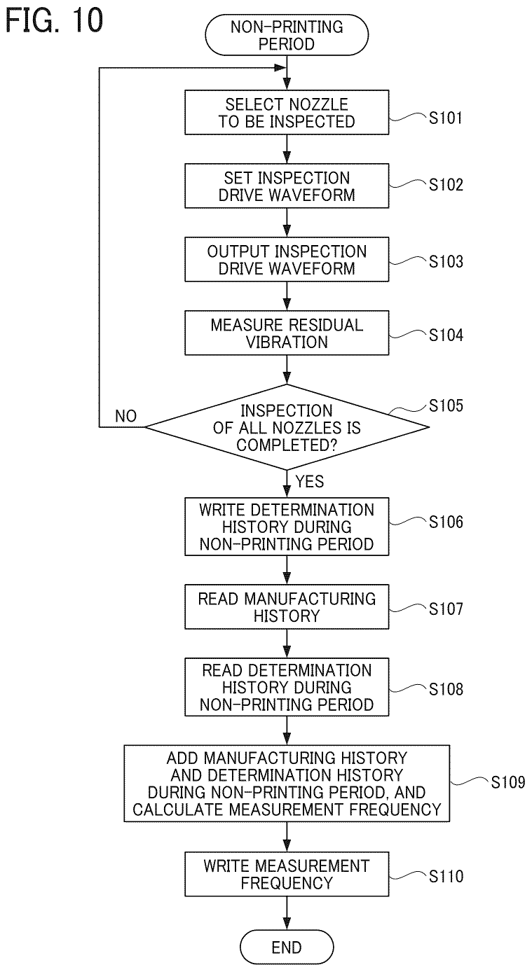

Hereinafter, a method of calculating and setting the measurement frequency will be described as an operation method using the inkjet recording head 15 according to the present embodiment with reference to FIGS. 10 and 11 to 13. FIG. 10 is a flowchart illustrating processing of calculating and setting the measurement frequency by the residual vibration measuring unit 41 executed in the inkjet recording head 15 of the inkjet recording apparatus 100 according to one or multiple embodiments of the present disclosure.

The processing illustrated in FIG. 10 is called in the non-printing period and starts from step S100.

Here, the non-printing period is, for example, a preparation stage after power-on of the inkjet recording apparatus 100, when performing maintenance, or before a print job is started. Here, an embodiment in which the non-printing inspection control unit 70 sets the measurement frequency according to the inspection during the printing period following the inspection of the discharge state of all the nozzles during the non-printing period will be described.

At step S101, the non-printing inspection control unit 70 selects the inspection target nozzle out of the multiple nozzles 16. Specifically, in a case of performing in order from the nozzle number 1, the nozzle of the nozzle number 1 is selected for the first time. At step S102, the non-printing inspection control unit 70 reads the inspection waveform stored in advance from the storing unit 40. At step S103, the non-printing inspection control unit 70 outputs the drive waveform data, and causes the drive waveform generation unit 39 to output an inspection drive waveform to the inkjet recording head 15. At step S104, the non-printing inspection control unit 70 causes the residual vibration measuring unit 41 to measure the residual vibration as for the selected inspection target nozzle, and causes the discharge state determination unit 75 to determine the discharge state of the selected nozzle.

At step S105, the non-printing inspection control unit 70 determines whether residual vibration inspection of all the nozzles is completed. In a case where it is determined at step S105 that the inspection of all the nozzles is not completed yet (NO), the procedure returns to step S101. In this case, the nozzle number is incremented (added), and the procedure proceeds to the inspection of a next nozzle. In contrast, in a case where it is determined at step S105 that the inspection of all the nozzles is completed (YES), the procedure proceeds to step S106.

At step S106, the non-printing inspection control unit 70 stores the inspection results obtained at step S104 for all of the multiple nozzles 16 in the storing unit 58 of the inkjet recording head 15. The stored information is the determination history at the time of non-printing.

At step S107, the non-printing inspection control unit 70 causes the frequency calculation unit 71 to read the manufacturing history from the storing unit 58.

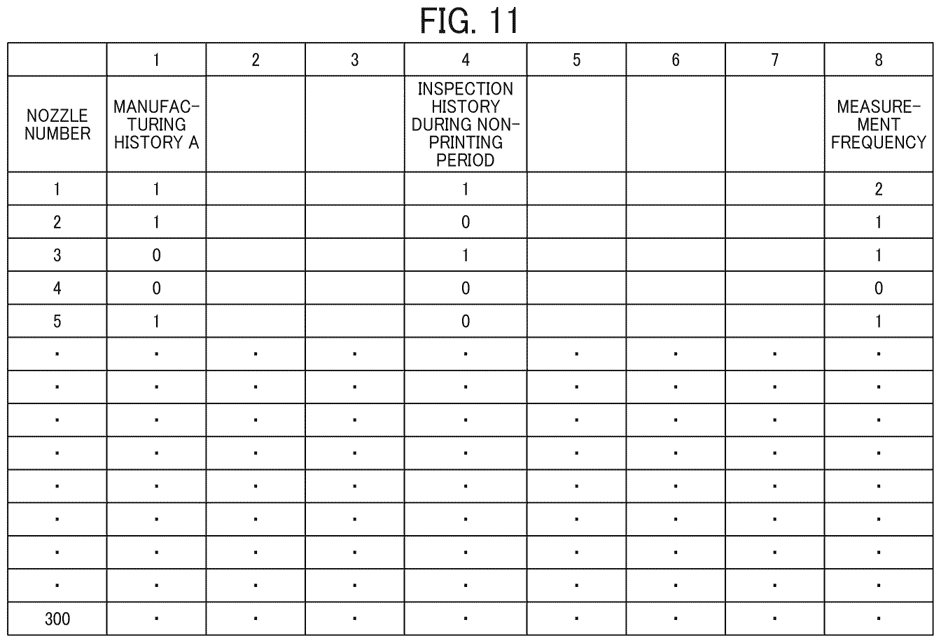

FIG. 11 illustrates a data structure of contents stored in the storing unit 58 of the inkjet recording head 15 according to the embodiment of the present disclosure. In the data structure illustrated in FIG. 11, rows correspond to the nozzle numbers, in which the nozzle number 1 is allocated to the uppermost row, and the nozzle number 300 is allocated to the lowermost row. The numbers and the number of nozzles are merely examples. Addresses 1 to 8 are allocated to columns other than the nozzle numbers. The address 1 is information indicating an inspection history when manufacturing (manufacturing history A). In the address 1, it is held whether the nozzle is the nozzle in which non-discharge occurs at an image printing step but recovered by recovery processing in the inspection when manufacturing, whether the nozzle is the nozzle in which some inspection results do not reach a predetermined value on an image but having a significant difference from other nozzles, and whether the nozzle is the nozzle in which a discharge speed falls within a standard value but having a significant decreasing trend in a part of the nozzle line. In FIG. 11, any of the values of the multiple items of the manufacturing history described above or a value obtained by collecting the multiple items of the manufacturing history will be described as being held at the address 1, but a value for each individual item of the manufacturing history may be held at the address 2 or address 3.

As an example of a specific recording method, in a case where the discharge speed is within the standard value, but a clear decreasing trend occurs in the nozzle of the nozzle number 1, the value of the address 1 corresponding to the nozzle number 1 is stored as “1”. In a case where there is no particular disadvantage, the value of the corresponding address 1 is stored as “0”.

At step S108, the non-printing inspection control unit 70 further reads the determination history at the time of non-printing from the storing unit 58 by the frequency calculation unit 71.

In the data structure illustrated in FIG. 11, the inspection results obtained at step S104 for all of the multiple nozzles 16 are stored at step S106. The value of the address 4 in FIG. 11 is the inspection history at the time of non-printing stored at step S106. In a case where the nozzle state exceeds a predetermined threshold and it is determined that there is a possibility of non-discharge or the like, “1” is stored, and in a case where there is no particular disadvantage, “0” is stored.

At step S109, the non-printing inspection control unit 70 sets, by the frequency calculation unit 71, multiple measurement frequencies to be performed during the printing period for the multiple nozzles 16 based on the manufacturing history and the determination history at the time of non-printing stored in the storing unit 58. In a specific embodiment, the measurement frequency is calculated by adding a value indicating abnormality in the inspection history of the manufacturing history and a value indicating abnormality in the determination history at the time of non-printing. At step S109, the non-printing inspection control unit 70 writes the measurement frequency in the storing unit 58 by the frequency setting unit 72, and ends the present processing at step S111.

The address 8 in the data structure illustrated in FIG. 11 holds the measurement frequency of the inspection performed during printing. In the example illustrated in FIG. 11, the values of the addresses 1 to 7 are added for each nozzle number and stored in an area of the address 8. Therefore, the measurement frequency of the nozzle corresponding to the nozzle number having the largest value of the address 8 is the highest.

The example illustrated in FIG. 11 corresponds to the embodiment in which the frequency calculation unit 71 adds a value of the manufacturing history (value indicating abnormality) and a value of the determination history during the non-printing period (value indicating abnormality), and determines the measurement frequency based on a result of the addition for each nozzle.

For example, in the data structure illustrated in FIG. 11, the nozzle having the measurement frequency equal to or higher than a threshold is set as the inspection target during the printing period as the high-frequency inspection node group. Alternatively, based on a numerical range to which the measurement frequency belongs, it is divided into multiple groups such as a group on which high-frequency inspections are performed, a group on which medium-frequency inspections are performed, and a group on which normal-frequency inspections are performed. Alternatively, only nozzles having a measurement frequency equal to or higher than the threshold may be the inspection target during the printing period (that is, those having a frequency equal to or less than the threshold may be set as zero frequency and may be excluded from the inspection target during printing). Specifically, in the measurement frequency of FIG. 11, when the threshold is set to 1, only nozzles having a value of 1 or larger can be made the inspection target during the printing period.

With the setting of the measurement frequency according to the embodiment described above, it is possible to intensively inspect the nozzle for which it is determined from the manufacturing history that there is a sign of occurrence of abnormality, so that, even if discharge abnormality caused by a state when manufacturing occurs during printing, it is possible to quickly detect the abnormality. Since multiple pieces of history information including the manufacturing history is referred to, it is expected that the accuracy of abnormality detection is improved.

Since the measurement frequency of the storing unit 58 is stored in advance in the non-printing period and is read before printing is started, printing is not accompanied by a large amount of processing time. Furthermore, since the manufacturing history can be used for abnormality determination, the accuracy of detection of abnormality caused by the state when manufacturing can be improved. By reading out the information of the measurement frequency from the storing unit 58, the abnormality frequency of the nozzle can be grasped, and it can be used for failure prediction and analysis when recovering an abnormal head. Furthermore, since the measurement frequency is set based on both the inspection history when manufacturing and the inspection result at the time of non-printing, the discharge abnormality can be detected at an early stage with high accuracy in consideration of the state when manufacturing and a current state.

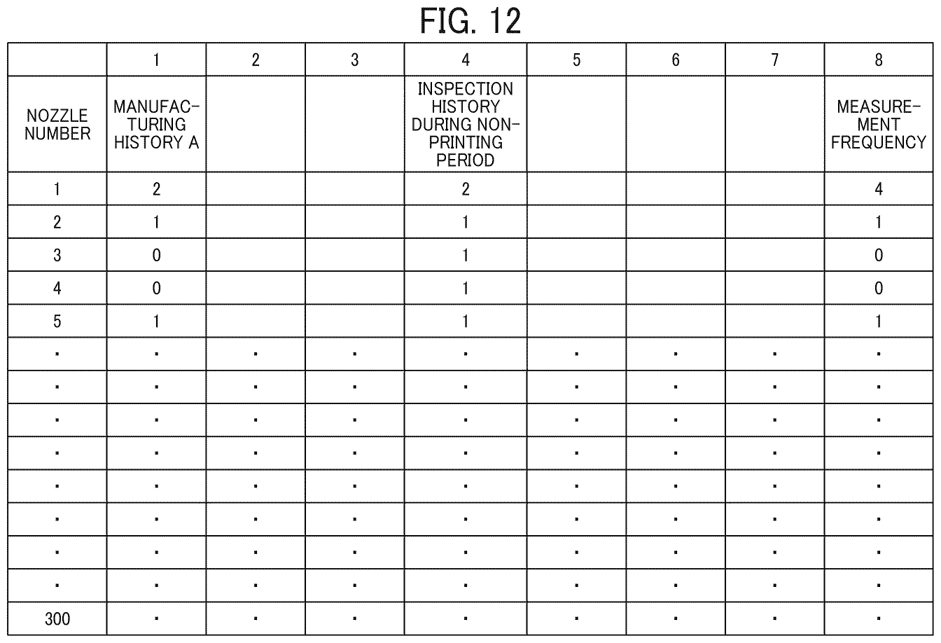

The method of adding illustrated in FIG. 11 is an example, and other calculation formulae and calculation methods are also intended. For example, FIG. 12 illustrates a data structure corresponding to the embodiment in which the frequency calculation unit 71 multiplies a value of the manufacturing history (value indicating abnormality) and a value of the determination history during the non-printing period (value indicating abnormality), and determines the measurement frequency based on a result of the multiplication for each nozzle. In the example illustrated in FIG. 12, the measurement frequency is determined by multiplying the value of the history when manufacturing stored in the address 1 by the value of the determination history at the time of non-printing described in the address 4. The inspection history when manufacturing is classified into 0 to 2 and stored in the address 1, and the nozzle number in which 2 is stored as a value is a point where it is estimated that the nozzle abnormality is likely to occur from the inspection history when manufacturing. Since the value of the address 1 at which the information of the manufacturing history is stored is multiplied by the value of the address 4 at which the determination history at the time of non-printing, and the obtained value is stored in the area of the address 8, the measurement frequency of the nozzle of the nozzle number having the largest value of the address 8 is the highest. In a calculation method illustrated in FIG. 12, when a value of a specific inspection history in which the life reduction, the failure, and the like are concerned is increased, the value of the inspection frequency can be set high by multiplication. As a result, the discharge abnormality caused by the state when manufacturing can be detected earlier.

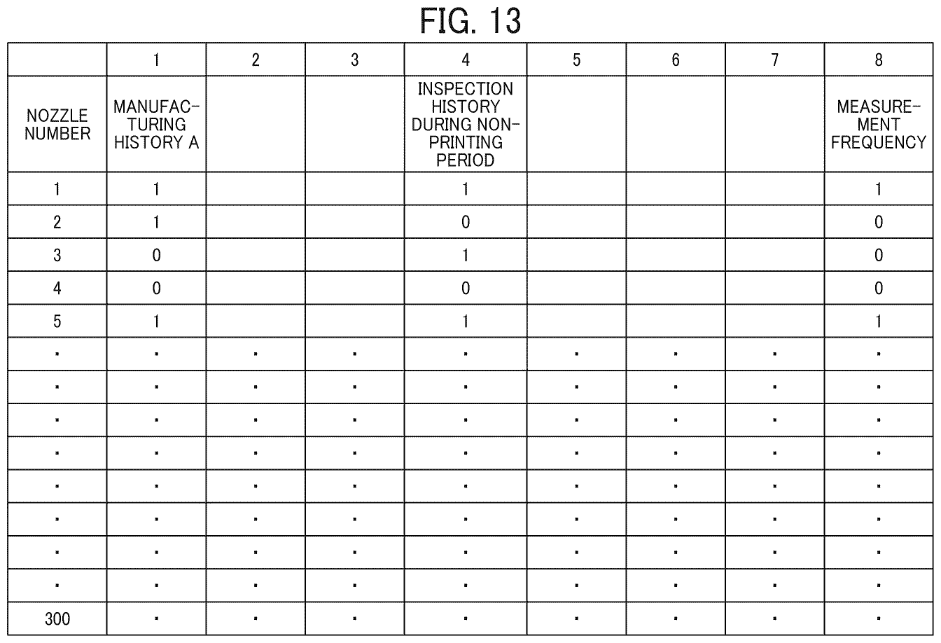

FIG. 13 illustrates still another embodiment, and the example illustrated in FIG. 13 illustrates a data structure corresponding to the embodiment in which the frequency calculation unit 71 obtains an AND result by performing a logical AND operation on a value of the non-discharge history (indicating abnormality) and a value of the non-printing-period determination-history value (indicating abnormality), and determines the measurement frequency based on the AND result.

In the embodiment illustrated in FIG. 13, the measurement frequency is determined by a logical AND condition between the value of the history when manufacturing stored in the address 1 and the value of the inspection history at the time of non-printing stored in the address 4. In a case where both the value of the address 1 and the value of the address 4 are 1, the inspection frequency of the address 8 is set to 1.

According to the embodiment described above, there are provided the liquid discharge apparatus, the liquid discharge head, the image forming apparatus, and the operation method using the liquid discharge head that can detect at an early stage the discharge abnormality caused by the state when manufacturing.

According to the above-described method, even if discharge abnormality caused by the state when manufacturing occurs during printing, detection at an early stage is possible. Since the measurement frequency is calculated based on the information stored in advance when manufacturing the head and the already stored information such as the determination history performed during the non-printing period, a large amount of processing time is not involved during printing.

In the embodiment described above, a so-called rotary printer in which an image is formed by printing ink discharged from the inkjet recording module 8 on the conveyed continuous recording medium M has been described as an example. However, the inkjet type image forming apparatus according to the embodiment of the present disclosure is not limited to the rotary printer, and may be configured as a sheet printer, and is not limited thereto.

In the present disclosure, discharged “liquid” is not particularly limited as long as this has a viscosity or surface tension that can be discharged from the head, however, preferably, the viscosity of the liquid is 30 mPa s or less under ordinary temperature and ordinary pressure or by heating or cooling. Specific examples of the liquid include a solution, a suspension, or an emulsion including a solvent such as water or an organic solvent, a colorant such as dye or pigment, a functionality imparting material such as a polymerizable compound, a resin, a surfactant, a biocompatible material such as deoxyribonucleic acid (DNA), amino acid, protein, or calcium, and an edible material such as a natural colorant. They can be used for, for example, inkjet ink, surface treatment solution, a liquid for forming components of electronic element or light-emitting element or a resist pattern of electronic circuit, or a material solution for three-dimensional fabrication.

The “liquid discharge head” includes a head that uses a piezoelectric actuator (laminated piezoelectric element and thin film piezoelectric element) or the like as an energy generation source for discharging liquid.

The term “liquid discharge apparatus” used herein includes an apparatus that drives the liquid discharge head to discharge liquid. The liquid discharge apparatus may be any apparatus that can discharge liquid to a medium onto which liquid can adhere or any apparatus to discharge liquid toward gas or into a different liquid.

The “liquid discharge apparatus” may further include means relating to feeding, conveying, and ejecting of the medium onto which liquid can adhere and also include a pretreatment device and an aftertreatment device.

The “liquid discharge apparatus” may be, for example, an image forming apparatus to form an image on a paper sheet by discharging ink, an inkjet recording module as a component thereof, or a three-dimensional fabrication apparatus to discharge a fabrication liquid to a powder layer in which powder material is formed in layers to form a three-dimensional fabrication object.

The term “liquid discharge apparatus” is not limited to an apparatus to discharge liquid to visualize meaningful images, such as letters or figures. For example, the liquid discharge apparatus may be an apparatus that forms patterns having no meaning or an apparatus that fabricates three-dimensional images.

The above-described term “medium onto which liquid can adhere” represents a medium on which liquid can be at least temporarily adhered, a medium on which liquid is adhered and fixed, or a medium into which liquid adheres and permeates. Specific examples of the “medium onto which liquid can adhere” include a recording medium such as a paper sheet, recording paper, a recording sheet of paper, a film, or cloth, an electronic component such as an electronic substrate or a piezoelectric element, and a medium such as layered powder, an organ model, or a testing cell. The “medium onto which liquid can adhere” includes any medium to which liquid adheres, unless otherwise specified.

Examples of the “material onto which liquid can adhere” include any materials on which liquid can adhere even temporarily, such as paper, thread, fiber, fabric, leather, metal, plastic, glass, wood, and ceramic.

The term “liquid discharge apparatus” may be an apparatus in which the liquid discharge head and the medium onto which liquid can adhere move relative to each other. However, the liquid discharge apparatus is not limited to such an apparatus. For example, the liquid discharge apparatus may be a serial head apparatus that moves the liquid discharge head or a line head apparatus that does not move the liquid discharge head.

Examples of the liquid discharge apparatus further include a treatment liquid applying apparatus that discharges a treatment liquid onto a paper sheet to apply the treatment liquid to the surface of the paper sheet, for reforming the surface of the paper sheet, and an injection granulation apparatus that injects a composition liquid, in which a raw material is dispersed in a solution, through a nozzle to granulate fine particle of the raw material.

The terms “image formation”, “recording”, “letter printing”, “printing”, “image printing”, and “fabricating” used herein may be used synonymously with each other.

A liquid discharge apparatus includes a liquid discharge head (15) and circuitry. The liquid discharge head (15) includes multiple nozzles (16) to discharge a liquid during a printing period; multiple pressure chambers (16) respectively communicating with the multiple nozzles; and a memory (58) that stores a manufacturing history including a discharge history of each of the multiple nozzles (16) at a time of manufacturing the multiple nozzles (16). The circuitry is configured to measure a residual vibration generated in each of the multiple pressure chambers during a non-printing period, set a measurement frequency for each of the multiple nozzles based on the manufacturing history stored in the memory (58) and the residual vibration measured, and select a target nozzle, to be measured during the printing period, from the multiple nozzles (16) based on the measurement frequency.

The circuitry is further configured to determine a discharge state of each of the multiple nozzles, to one of a normal nozzle or an abnormal nozzle, based on the residual vibration measured during the printing period; store, in the memory, a determination history of determining the discharge state of each of the multiple nozzles; identify the abnormal nozzle indicating both of abnormality in the manufacturing history and the abnormal nozzle in the determination history; increase the measurement frequency for the abnormal nozzle to be higher than the measurement frequency of the normal nozzle, to set the measurement frequency for each of the multiple nozzles.

The liquid discharge apparatus further includes a pressure chamber plate (21) including the multiple pressure chambers (20); and multiple piezoelectric elements (31) respectively facing the multiple pressure chambers (20). The multiple piezoelectric elements (31) displace the multiple pressure chambers (20) to discharge the liquid in the multiple pressure chambers from the multiple nozzles, respectively. The circuitry is further configured to generate a drive waveform to drive at least one of the multiple piezoelectric elements corresponding to the target nozzle; and measure the residual vibration of at least one of the multiple pressure chambers (20) corresponding to the target nozzle.

The circuitry selects the target nozzle; and the piezoelectric element corresponding to the target nozzle, at a timing of interruption during the printing period.

The circuitry is further configured to select the target nozzle having the measurement frequency equal to or higher than a threshold.

The circuitry is further configured to, for each of the multiple nozzles, add a value of the manufacturing history and a value of the determination history to obtain an addition result; and determine the measurement frequency based on the addition result.

The circuitry is further configured to, for each of the multiple nozzles, multiply a value of the manufacturing history and a value of the determination history to obtain a multiplication result and determine the measurement frequency based on the multiplication result.

The circuitry is further configured to, for each of the multiple nozzles, perform a logical AND operation on a value of the manufacturing history and a value of the determination history to obtain a logical AND result and determine the measurement frequency based on the logical AND result.

An image forming apparatus includes the liquid discharge apparatus to discharge the liquid from the liquid discharge head onto a medium and to form an image on the medium during the printing period.

A liquid discharge head includes multiple nozzles (16) to discharge a liquid during a printing period; multiple pressure chambers (16) respectively communicating with the multiple nozzles; a memory (58) that stores a manufacturing history including a discharge history of each of the multiple nozzles (16) at a time of manufacturing the multiple nozzles (16); and circuitry configured to measure a residual vibration generated in each of the multiple pressure chambers during a printing period; store, in the memory:
a measurement frequency for each of the multiple nozzles set based on the manufacturing history stored in the memory (58) and the residual vibration measured; and a target nozzle, to be measured during the printing period, selected from the multiple nozzles (16) based on the measurement frequency.

In the liquid discharge head, the circuitry is further configured to store, in the memory: the discharge state of each of the multiple nozzles determined, to one of a normal nozzle or an abnormal nozzle, based on the residual vibration measured during the non-printing period; a determination history of the discharge state of each of the multiple nozzles determined; the abnormal nozzle indicating both of abnormality in the manufacturing history and the abnormal nozzle in the determination history identified; the measurement frequency for the abnormal nozzle increased to be higher than the measurement frequency of the normal nozzle; and the measurement frequency set for each of the multiple nozzles.

An operation method includes storing, in a memory, a manufacturing history including a discharge history of each of multiple nozzles (16) of a liquid discharge head (15) to discharge a liquid during a printing period, at a time of manufacturing the multiple nozzles (16); and measuring a residual vibration generated in each of multiple pressure chambers of the liquid discharge head, during a non-printing period; and setting a measurement frequency for each of the multiple nozzles based on the manufacturing history stored in the memory (58) and the residual vibration measured; selecting a target nozzle, to be measured during the printing period, from the multiple nozzles (16) based on the measurement frequency.

The operation method further includes determining a discharge state of each of the multiple nozzles, to one of a normal nozzle or an abnormal nozzle, based on the residual vibration measured during the non-printing period; storing, in the memory, a determination history of determining the discharge state of each of the multiple nozzles; identifying the abnormal nozzle indicating both of abnormality in the manufacturing history and the abnormal nozzle in the determination history; and increasing the measurement frequency for the abnormal nozzle to be higher than the measurement frequency of the normal nozzle, to set the measurement frequency for each of the multiple nozzles.

Each of the functions of the above-described embodiments may be implemented by one or more processing circuits or circuitry. Here, the term “processing circuit or circuitry” in the present embodiment includes a programmed processor to execute each function by software, such as a processor implemented by an electronic circuit, and devices, such as an application specific integrated circuit (ASIC), a digital signal processor (DSP), a field programmable gate array (FPGA), a system on a chip (SOC), a graphics processing unit (GPU), and conventional circuit modules designed to execute each function described above.

The functions described above may be implemented by a computer-executable program described in a legacy programming language such as assembler, C, C++, C#, and Java (registered trademark), an object-oriented programming language or the like, and may be distributed in a manner stored in a device-readable recording medium such as a read only memory (ROM), an electrically erasable programmable read only memory (EEPROM), an erasable programmable read only memory (EPROM), a flash memory, a flexible disk, a compact disc read-only memory (CD-ROM), a compact disc-rewritable (CD-RW), a digital versatile disc read-only memory (DVD-ROM), a digital versatile disc-random access memory (DVD-RAM), a digital versatile disc-rewritable (DVD-RW), a Blu-ray disc, a secure digital (SD) card, or a magneto-optical disk (MO), or via an electric communication line.

Although the liquid discharge apparatus, the image forming apparatus, the liquid discharge head, and the operation method using the liquid discharge head according to the embodiment of the present disclosure have been described so far, the present invention is not limited to the above-described embodiment, and can be changed within a range that can be conceived by those skilled in the art, such as addition, change, or deletion of other embodiments, and any aspect is included in the scope of the present invention as long as the function and effect of the present invention are exhibited.

Aspects of the present disclosure are as follows, for example.

### Aspect 1

According to Aspect 1, a liquid discharge apparatus includes multiple nozzles; a measuring unit that is provided in common for the multiple nozzles, the measuring unit for measuring vibration generated in a nozzle selected out of the multiple nozzles; a first storing unit that stores a manufacturing history (a non-discharge history) as for the multiple nozzles; and a setting unit that sets multiple measurement frequencies by the measuring unit during a processing operation for the multiple nozzles based on the manufacturing history.

### Aspect 2

According to Aspect 2, the liquid discharge apparatus of Aspect 1 further includes: a determination unit that determines a discharge state of each of the multiple nozzles based on an output of the measuring unit; and a second storing unit that stores a determination history obtained by determining discharge states of the multiple nozzles by the determination unit during a non-processing operation period as for the multiple nozzles, in which the setting unit sets the measurement frequencies for the multiple nozzles for each nozzle so that a measurement frequency of a nozzle that indicates abnormality in the manufacturing history and indicates abnormality in the determination history during the non-processing operation period is relatively higher than the measurement frequency of other nozzles.

### Aspect 3

According to Aspect 3, the liquid discharge apparatus of Aspect 2 further includes multiple pressure chambers communicating with the multiple nozzles to store ink; multiple piezoelectric elements provided for the multiple nozzles, respectively; and a generation unit that generates a drive waveform for driving the multiple piezoelectric elements, in which the multiple piezoelectric elements is arranged so as to be opposed to the multiple pressure chambers and configured to pressurize the multiple pressure chambers, respectively, and the measuring unit is configured to measure residual vibration generated in a corresponding pressure chamber with a selected piezoelectric element after the selected piezoelectric element is driven.

### Aspect 4

According to Aspect 4, the liquid discharge apparatus of Aspect 3 further includes: a selection unit that selects a part of the nozzles and a part of the piezoelectric elements corresponding to the part as an inspection target at a break timing during the processing operation.

### Aspect 5

According to Aspect 5, in the liquid discharge apparatus of any one of Aspects 2 to 4, a nozzle having the measurement frequency equal to or higher than a threshold is made an inspection target during the processing operation.

### Aspect 6

According to Aspect 6, the liquid discharge apparatus of any one of Aspects 2 to 4 further includes: a calculation unit that adds a value of the manufacturing history and a value of the determination history and determines the measurement frequency based on a result of the addition for each nozzle.

### Aspect 7

According to Aspect 7, the liquid discharge apparatus of any one of Aspects 2 to 4 further includes: a calculation unit that multiplies a value of the manufacturing history and a value of the determination history and determines the measurement frequency based on a result of the multiplication for each nozzle.

### Aspect 8

According to Aspect 8, the liquid discharge apparatus of any one of Aspects 2 to 4 further includes: a calculation unit that obtains a logical AND of a value of the manufacturing history (or the non-discharge history) and a value of the determination history and determines the measurement frequency based on a result of the logical AND for each nozzle.

### Aspect 9

According to Aspect 9, an image forming apparatus includes: the liquid discharge apparatus of any one of Aspects 1 to 7, in which the processing operation is printing.

### Aspect 10

According to Aspect 10, a liquid discharge head includes: multiple nozzles; a measuring unit that is provided in common for the multiple nozzles, the measuring unit for measuring vibration generated in a nozzle selected out of the multiple nozzles; a first storing unit that stores a manufacturing history as for the multiple nozzles; and a setting storing unit that stores multiple measurement frequencies by the measuring unit during a processing operation for the multiple nozzles according to the manufacturing history.

### Aspect 11

According to Aspect 11, the liquid discharge head of Aspect 10 further includes: a second storing unit that stores a determination history obtained by determining discharge states of the multiple nozzles based on an output of the measuring unit during a non-processing operation period for the multiple nozzles.

### Aspect 12

According to Aspect 12, an operation method is: n operation method using a liquid discharge head including multiple nozzles and a measuring unit that is provided in common for the multiple nozzles for measuring vibration generated for a nozzle selected out of the multiple nozzles, the operation method including: reading a manufacturing history for the multiple nozzles from a first storing unit; and setting multiple measurement frequencies by the measuring unit during a processing operation for the multiple nozzles based on the read manufacturing history.

### Aspect 13

According to Aspect 13, the operation method of Aspect 12 includes: determining a discharge state of each of the multiple nozzles based on an output of the measuring unit during a non-processing operation period; and storing a determination history of the non-processing operation period including determined discharge states of the multiple nozzles, in which the setting includes setting the measurement frequencies for the multiple nozzles for each nozzle so that a measurement frequency of a nozzle that indicates abnormality in the manufacturing history and indicates abnormality in the determination history during the non-processing operation period is relatively higher than the measurement frequency of other nozzles.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A liquid discharge apparatus comprising:
a liquid discharge head including:
multiple nozzles to discharge a liquid during a printing period;
multiple pressure chambers respectively communicating with the multiple nozzles; and
a memory that stores a manufacturing history including a discharge history of each of the multiple nozzles at a time of manufacturing the multiple nozzles; and
circuitry configured to:
measure a residual vibration generated in each of the multiple pressure chambers during a non-printing period;
set a measurement frequency for each of the multiple nozzles based on:
the manufacturing history stored in the memory; and
the residual vibration measured; and
select a target nozzle, to be measured during the printing period, from the multiple nozzles based on the measurement frequency.

2. The liquid discharge apparatus according to claim 1, wherein:
the circuitry is further configured to:
determine a discharge state of each of the multiple nozzles, to one of:
a normal nozzle; or
an abnormal nozzle,
based on the residual vibration measured during the non-printing period;
store, in the memory, a determination history of determining the discharge state of each of the multiple nozzles;
identify the abnormal nozzle indicating both of:
abnormality in the manufacturing history; and
the abnormal nozzle in the determination history; and
increase the measurement frequency for the abnormal nozzle to be higher than the measurement frequency of the normal nozzle,
to set the measurement frequency for each of the multiple nozzles.

3. The liquid discharge apparatus according to claim 2, further comprising:
a pressure chamber plate including the multiple pressure chambers; and
multiple piezoelectric elements respectively facing the multiple pressure chambers,
the multiple piezoelectric elements to displace the multiple pressure chambers to discharge the liquid in the multiple pressure chambers from the multiple nozzles, respectively,
wherein the circuitry is further configured to:
generate a drive waveform to drive at least one of the multiple piezoelectric elements corresponding to the target nozzle; and
measure the residual vibration of at least one of the multiple pressure chambers corresponding to the target nozzle.

4. The liquid discharge apparatus according to claim 3, wherein:
the circuitry is further configured to select:
the target nozzle; and
the piezoelectric element corresponding to the target nozzle,
at a timing of interruption during the printing period.

5. The liquid discharge apparatus according to claim 2, wherein:
the circuitry is further configured to:
select the target nozzle having the measurement frequency equal to or higher than a threshold.

6. The liquid discharge apparatus according to claim 2, wherein:
the circuitry is further configured to, for each of the multiple nozzles:
add a value of the manufacturing history and a value of the determination history to obtain an addition result; and
determine the measurement frequency based on the addition result.

7. The liquid discharge apparatus according to claim 2, wherein:
the circuitry is further configured to, for each of the multiple nozzles:
multiply a value of the manufacturing history and a value of the determination history to obtain a multiplication result; and
determine the measurement frequency based on the multiplication result.

8. The liquid discharge apparatus according to claim 2, wherein:
the circuitry is further configured to, for each of the multiple nozzles:
perform a logical AND operation on a value of the manufacturing history and a value of the determination history to obtain a logical AND result; and
determine the measurement frequency based on the logical AND result.

9. An image forming apparatus comprising:
the liquid discharge apparatus according to claim 1,
to discharge the liquid from the liquid discharge head onto a medium, and
to form an image on the medium during the printing period.

10. A liquid discharge head comprising:
multiple nozzles to discharge a liquid during a printing period;
multiple pressure chambers respectively communicating with the multiple nozzles;
a memory that stores a manufacturing history including a discharge history of each of the multiple nozzles at a time of manufacturing the multiple nozzles; and
circuitry configured to:
measure a residual vibration generated in each of the multiple pressure chambers during a printing period; and
store, in the memory:
a measurement frequency for each of the multiple nozzles set based on:
the manufacturing history stored in the memory; and
the residual vibration measured; and
a target nozzle, to be measured during the printing period, selected from the multiple nozzles based on the measurement frequency.

11. The liquid discharge head according to claim 10; wherein:
the circuitry is further configured to store, in the memory:
the discharge state of each of the multiple nozzles determined, to one of:
a normal nozzle; or
an abnormal nozzle,
based on the residual vibration measured during the non-printing period;
a determination history of the discharge state of each of the multiple nozzles determined;
the abnormal nozzle indicating both of:
abnormality in the manufacturing history; and
the abnormal nozzle in the determination history identified;
the measurement frequency for the abnormal nozzle increased to be higher than the measurement frequency of the normal nozzle; and
the measurement frequency set for each of the multiple nozzles.

12. An operation method comprising:
storing, in a memory, a manufacturing history including a discharge history of each of multiple nozzles of a liquid discharge head to discharge a liquid during a printing period, at a time of manufacturing the multiple nozzles; and
measuring a residual vibration generated in each of multiple pressure chambers of the liquid discharge head, during a non-printing period;
setting a measurement frequency for each of the multiple nozzles based on:
the manufacturing history stored in the memory; and
the residual vibration measured; and
selecting a target nozzle, to be measured during the printing period, from the multiple nozzles based on the measurement frequency.

13. The operation method according to claim 12, further comprising:
determining a discharge state of each of the multiple nozzles, to one of:
a normal nozzle; or
an abnormal nozzle,
based on the residual vibration measured during the non-printing period;
storing, in the memory, a determination history of determining the discharge state of each of the multiple nozzles;
identifying the abnormal nozzle indicating both of:
abnormality in the manufacturing history; and
the abnormal nozzle in the determination history;
increasing the measurement frequency for the abnormal nozzle to be higher than the measurement frequency of the normal nozzle,
to set the measurement frequency for each of the multiple nozzles.
